(19) United States
(12) Patent Application Publication
(10) Pub. No.: US 2010/0036546 A1
(43) Pub. Date: Feb. 11, 2010

(54) SECURITY APPARATUS FOR PNEUMATICALLY OPERATED DEVICES MOUNTED ON A VEHICLE

(75) Inventors: Celio J. Gomes, York, ME (US); David F. Rivers, Wallingford, CT (US)

Correspondence Address: O''Shea Getz P.C., 1500 MAIN ST. SUITE 912, SPRINGFIELD, MA, 01115, US

(73) Assignee: PATRIOT LIFT CO., LLC, Kingshill, St. Croix, VI (US)

(21) Appl. No.: 12/537,605

(22) Filed: Aug. 7, 2009

Related U.S. Application Data
(60) Provisional application No. 61/086,969, filed on Aug. 7, 2008.

(51) Int. Cl. G06F 7/00; G01S 1/00

(52) U.S. Cl. 701/2; 342/357.09; 701/1

(57) ABSTRACT

A method for securing a vehicle having at least one powered component includes the steps of: (i) providing a security system having a GPS sensor and at least one actuator located with the vehicle, which actuator is operable to enable or disable the powered component; (ii) providing a locator signal indicative of a geographical position of the vehicle via the GPS sensor; and (iii) enabling or disabling the powered component via the actuator based on the geographical position of the vehicle.

### PRIORITY INFORMATION

This patent application claims priority from U.S. Provisional Application No. 61/086,969 filed Aug. 7, 2008, which is hereby incorporated by reference in its entirety.

### BACKGROUND OF THE INVENTION

1. Technical Field

This disclosure relates generally to vehicle operating and security systems and, more particularly, to pneumatically, hydraulically and/or electrically actuated vehicle operating and security systems.

2. Background Information

It is known to use pneumatically powered components on vehicles; e.g., trucks, tractor-trailers, etc. Almost all of the pneumatically powered, electrically powered or hydraulically powered components employ some type of control device that controls either the characteristics of the air entering and/or exiting a pneumatic motor, or likewise the electric power available to an electric motor, or hydraulic fluid available to the hydraulic pump. In doing so, the control unit controls the direction the motor is operating, or the speed at which it moves, or the amount of power generated by the motor, or any combination of such characteristics.

In the trucking industry, it is common for a truck, a tractor-trailer, or trailer portion of a tractor trailer to be left at a business. Indeed, many freight carriers have hundreds of trucks and trailers that are deployed at any given time, including a large number that are left at businesses, waiting to be loaded and/or unloaded. Unfortunately, many of these trucks and trailers are subject to criminal activity, wherein the truck or trailer itself or just the contents thereof can be stolen. The cost and disruption to business caused by this criminal activity can be enormous. Keeping track of a large number of trucks and trailers can be a daunting task. This is particularly true if there is no centralized oversight.

What is needed is an apparatus and method that can provide security for a vehicle, which vehicle has one or more pneumatically powered components, or electrically powered components, or hydraulically powered components, and one that can enable a user to oversee the security of a number of vehicles from a single position.

### SUMMARY OF THE DISCLOSURE

According to one aspect of the invention, a security system is provided for a vehicle having at least one powered component. The security system includes a global positioning system (GPS) sensor, a vehicle controller, a base controller and an actuator. The GPS sensor is located with the vehicle, and produces a location signal indicative of a geographical position of the vehicle. The vehicle controller is located with the vehicle, and receives a base control signal and selectively provides an actuator control signal in response to the base control signal. The base controller is located independent of the vehicle, and receives the location signal and selectively transmits the base control signal to the vehicle controller in response to the location signal. The actuator is located with the vehicle, and selectively enables or disables the powered component in response to the actuator control signal.

According to another aspect of the invention, a method is provided for securing a vehicle having at least one powered component. The method includes the steps of (i) providing a security system having a GPS sensor and at least one actuator located with the vehicle, which actuator is operable to enable or disable the powered component; (ii) providing a locator signal indicative of a geographical position of the vehicle via the GPS sensor; and (iii) enabling or disabling the powered component via the actuator based on the geographical position of the vehicle.

Advantageously, the present invention can provide additional security for vehicles having one or more pneumatically powered, hydraulically powered and/or electrically powered components. For example, where a trailer is parked in a loaded condition, the present invention may be used to lock a lift gate and thereby secure goods stored within the trailer; i.e., the locked lift gate prevents unauthorized persons from opening rear trailer doors. However, when an authorized user returns to the trailer, the goods may be accessed and unloaded upon receiving permission sent from the base controller. In another example, the present invention may be used to lock the lift gate such that the goods are secured within the trailer during transit from both the driver and unauthorized persons. In another example, the present invention may be used to lock trailer landing gear in an extended position such that unauthorized persons may not couple their tractor to the trailer and subsequently drive away with the trailer and the goods stored therewithin. In still another example, the present invention may be used to prevent a driver from mistakenly coupling to and driving away with the wrong trailer; e.g., the driver may only be authorized to operate the trailer landing gear on a particular trailer.

### BRIEF DESCRIPTION OF THE DRAWING

FIG. 1 is a diagrammatic illustration of a power system and a security system for a vehicle.

### DETAILED DESCRIPTION OF THE INVENTION

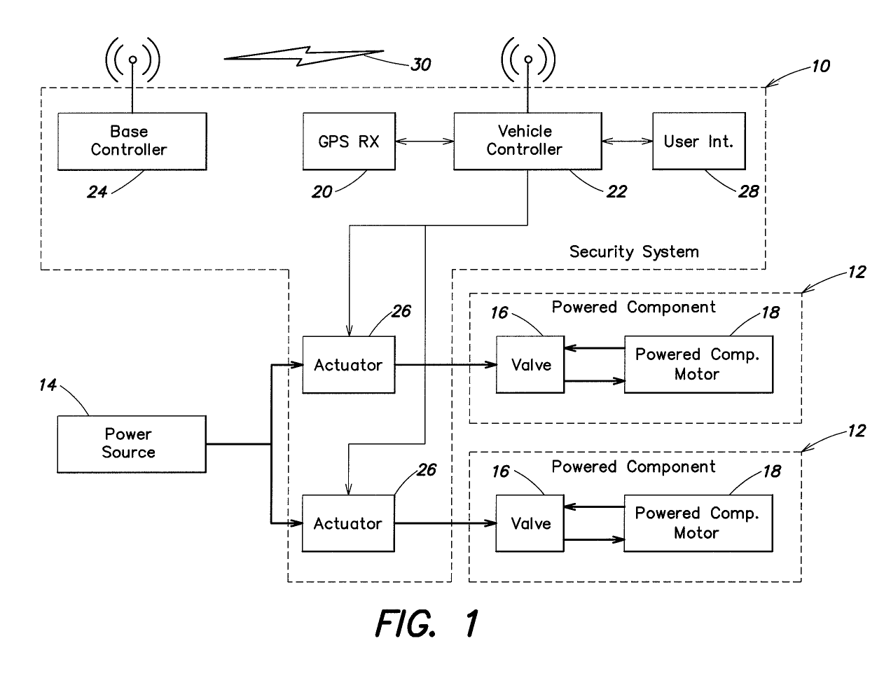

FIG. 1 is a diagrammatic illustration of a power system and a security system 10 for a vehicle such as a trailer (not shown). The term “vehicle” as used herein is not to be limited to trucks, tractor-trailer trucks, and trailers, but may also include over the road vehicles, construction equipment, construction vehicles, etc.

The power system includes one or more powered components 12 and a power source 14 located with the vehicle. The powered components 12 are configured as pneumatically, hydraulically and/or electrically driven components such as, but not limited to, trailer landing gear and/or a lift gate. Other powered components 12 with which the present invention may be used include, but are not limited to, a platform lift, rear stabilizers, a hopper gate, a locking mechanism of a vehicle door, a roll-top cover, etc. Each powered component 12 may include a control element 16 (e.g., a valve, regulator, switch, etc.) connected to a motor 18 in a typical fashion. Depending upon the nature of the powered component 12 (i.e., the control element 16 and/or the motor 18), the power source 14 may be a pneumatic power source (e.g., a vehicle emergency brake air source, air compressor, a compressed air reservoir, etc.), a hydraulic power source (e.g., a hydraulic pump) and/or an electric power source (e.g., a generator, an alternator, a battery, etc.). For simplicity, hereinafter, the power source 14, and thus the powered components 12, shall be described as pneumatically operated equipment. For example, the power source 14 shall be described as an air compressor operable to drive/propel (i.e., power) one or more of the powered components 12 via compressed air. However, the present invention is not limited to pneumatically operated equipment. Such power sources and powered components 12 are well known in the art, and the present invention is not limited to any particular configuration or type thereof.

The security system 10 is operable to enable or disable (e.g., permit or prevent operation of) one or more of the powered components 12 (e.g., the trailer landing gear and/or the lift gate) of the power system, which will be described below in further detail. The security system 10 includes a global positioning system (“GPS”) sensor 20, a vehicle controller 22, a base controller 24, one or more actuators 26 and optionally a user interface 28.

The GPS sensor 20 is configured to receive GPS signals (e.g., three or more satellite beacons) from a plurality of satellites (not shown), and to provide a locator signal. The locator signal is a function of the GPS signals and is indicative of a geographical position (e.g., latitude, longitude and/or altitude) of the vehicle. In some embodiments, the GPS sensor 20 is additionally configured as a transmitter for communicating signals from vehicle controller 22 to the base controller 24. The specific type of GPS sensor 20 can vary depending upon the application at hand. An example of an acceptable GPS sensor 20 is a typical GPS unit (e.g., a SkyBitz™ Global Locating System such as the GLS 210 Mobile Terminal, a General Electric VeriWise™ Asset Intelligence system, etc.) for tracking a current location of and/or plotting a route driven by the vehicle.

The vehicle controller 22 is configured to receive the locator signal, a user request signal (from the user interface 28) and/or a base control signal (from the base controller 24). The vehicle controller 22 is further configured to provide a data signal in response to the received locator and/or user request signals, and an actuator control signal in response to the received base control signal. In alternate embodiments, the actuator control signal can be provided in response to the received user request signal and/or the received locator signal. The data signal can include one or more of the following data: geographical data from the received locator signal, request data (e.g., indicating whether a user is attempting to or has operated one or more of the powered components 12), and/or identification data (e.g., identifying the user who is attempting to or has operated the powered components 12) from the received user request signal. The vehicle controller 22 may include hardware (e.g., a micro-processor, a programmable logic controller, etc.) that processes the received signals according to pre-programmed software. Additionally or alternatively, the vehicle controller 22 may include a compiler and/or a relay operable to compile and then relay the received signals to the base controller 24 and/or to one or more of the actuators 26. One example of an acceptable vehicle controller 22 is a WABCO™ Electronic Air Processing Unit (E-APU). In some embodiments, the vehicle controller 22 includes a plurality of vehicle control units; e.g., one vehicle control unit for each powered component 12.

The base controller 24 is configured to receive data signals and process the geographical data, the request data and/or the identification data represented within the data signals to determine whether a particular powered component(s) should be enabled or disabled. In some embodiments, the base controller 24 has the ability to display data (e.g., via a monitor) from the data signal and to receive input from a user. The base controller 24 is further configured to provide and transmit the base control signal, where the base control signal is indicative of a component enable command and/or a component disable command. For example, the base control signal may be indicative of a trailer landing gear enable command and a lift gate disable command. The base controller 24 may include hardware (e.g., a micro processor, etc.) that processes the received signals according to pre-programmed software.

The actuators 26 are adapted to enable and/or disable one or more of the powered components 12 (e.g., the trailer landing gear and/or the lift gate) in response to the actuator control signal. For example, the actuators 26 may be configured as electronically regulated solenoid valves that open when the actuator control signal includes a component enable command. In contrast, the valves may close when the actuator control signal includes a component disable command. In some embodiments, the actuators 26 are the same as the control elements for the powered components 12; e.g., the valve coupled to the motor of a particular powered component 12.

The user interface 28 is configured to receive identification and/or access request information from a user, and to provide a request signal indicative of the information input by the user. The user interface 28 may include a keypad, a fingerprint reader/scanner, or other input and/or identification devices.

The base controller 24 is disposed in a first location (e.g., an office building, mobile office, etc.) and the vehicle controller 22, the GPS sensor 20 and the user interface 28 are located with the vehicle in a second location, which second location is typically different than the first location. The base controller 24 is operable to communicate with the vehicle controller 22 through a wireless network 30 (e.g., a satellite network, a cellular network, a radio network, etc.). The vehicle controller 22 is also operable to communicate with the GPS sensor 20, one or more of the actuators 26 and/or the user interface 28. For example, in some embodiments, the vehicle controller 22 is hard-wired to the GPS sensor 20, the actuators 26 and the user interface 28. However, this invention is not limited to such hard-wired connections. In other embodiments, where the vehicle controller 22 includes a plurality of vehicle control units, each unit is configured in communication with a respective one of the actuators 26 (not shown).

The power system (i.e., the power source 14 and the powered components 12) is disposed with the vehicle. Alternatively, the power source 14 can be coupled to the vehicle, and thus the powered components 12; e.g., an air compressor disposed with a tractor that is coupled to the powered components 12 on the trailer via air hose(s). Each actuator 26 is configured to selectively couple the power source 14 (e.g., the air compressor) to one of the powered components 12 (e.g., the trailer landing gear or the lift gate).

During a first mode of operation, a user (e.g., a driver, shipping personnel, etc.) may request that one or more of the powered components 12 (e.g., the trailer landing gear and/or the lift gate) be enabled or disabled. For example, the driver may request for the trailer landing gear to be enabled when a tractor is coupled to the trailer, or for the trailer landing gear to be disabled when the trailer is left at an unsecured location (e.g., a shipping depot, rest area, etc.). In another example, the shipping personnel may request for the lift gate to be enabled when goods are loaded into or unloaded from the trailer. The user can make the request by inputting a code, a command and/or a message into the user interface 28. In some embodiments, the identity of the user is verified via the fingerprint scanner on the user interface 28.

Upon entering the request, the user interface 28 communicates the user request signal to the vehicle controller 22. Contemporaneously, the GPS sensor 20 communicates the locator signal to the vehicle controller 22. In response to the received user request signal and the received locator signal, the vehicle controller 22 communicates the data signal, which includes data indicative of the code, the command, the message and/or the geographical position of the trailer, to the base controller 24 through the wireless network 30.

The base controller 24 processes the data from the received data signal to determine whether the request by the user should be granted or denied; i.e., whether a particular powered component 12 should be enabled or disabled. For example, where the user is an authorized driver and the trailer is in an acceptable location (e.g., a shipping depot, a weight station, etc.), the base controller 24 may grant the request. In contrast, if the user is unauthorized and/or the trailer is in an unacceptable location (e.g., a location substantially off-route), the base controller 24 may deny the request. The request is granted when a component enable command is sent from the base controller 24 to the vehicle controller 22 via the base control signal. Similarly, the request is denied when a component disable command is sent from the base controller 24 to the vehicle controller 22 via the base control signal. Alternatively or in addition to, the user operating the base controller 24 may review the data from the data signal and decide whether to grant or deny the request.

The vehicle controller 22 controls each actuator 26 (e.g., the valve) by relaying the component enable command or the component disable command thereto via the actuator control signal. For example, where the base control signal includes a landing gear enable command, the vehicle controller 22 signals/prompts the valve connecting the air compressor to the trailer landing gear to open, thereby allowing compressed air to drive the landing gear motor. Thus, the trailer landing gear may be raised or lowered. In another example, where the base control signal includes a trailer landing gear disable command, the vehicle controller 22 signals/prompts the valve connecting the air compressor to the trailer landing gear to close, thereby preventing compressed air from driving the trailer landing gear motor. Thus, the trailer landing gear becomes inoperable.

During a second mode of operation, the user (e.g., the driver, the shipping personnel, etc.) may request that one or more of the powered components 12 (e.g., the trailer landing gear and/or the lift gate) be enabled or disabled. The user can make the request by inputting, for example, a code, a command and/or a message into the user interface 28. Upon entering the request, the user interface 28 communicates the user request signal to the vehicle controller 22. The vehicle controller 22 determines whether the user is an authorized user; i.e., whether the user has been granted access to (i.e., control of) a particular powered component 12. Subsequent to this determination, the vehicle controller 22 communicates the component enable command or the component disable command to the particular powered component 12 via the actuator control signal. In an alternate embodiment, the vehicle controller 22 relays the user request signal via the data signal to the base controller 24 for determining whether the user is an authorized user.

During a third mode of operation, the GPS sensor 20 communicates the locator signal to the vehicle controller 22. The vehicle controller 22 determines whether the vehicle is located in a pre-approved location (e.g., a secured shipping depot, a weigh/inspection station, etc.). When the vehicle is located in a pre-approved location, the vehicle controller 22 communicates the component enable command to one or more of the powered components 12 via the actuator control signal. When the vehicle is not located in a pre-approved location, the vehicle controller 22 communicates the component disable command to one or more of the powered components 12 via the actuator control signal. In an alternate embodiment, the vehicle controller 22, or the GPS sensor when configured as a transmitter, relays the locator signal (directly or indirectly via the data signal) to the base controller 24 for determining whether the vehicle is located in a pre-approved location.

While various embodiments of the present invention have been disclosed, it will be apparent to those of ordinary skill in the art that many more embodiments and implementations are possible within the scope of the invention. For example, the various modes of operation may be combined together and assigned different priorities; e.g., where the vehicle is not located in a pre-approved location, an override request may be entered into the user interface 28 such that one or more of the powered components 12 is enabled. Accordingly, the present invention is not to be restricted except in light of the attached claims and their equivalents.

What is claimed is:

1. A security system for a vehicle having at least one powered component, comprising:
a GPS sensor located with the vehicle, which sensor produces a location signal indicative of a geographical position of the vehicle;
a vehicle controller located with the vehicle, which vehicle controller receives a base control signal and selectively provides an actuator control signal in response to the base control signal;
a base controller located independent of the vehicle, which base controller receives the location signal and selectively transmits the base control signal to the vehicle controller; and
an actuator located with the vehicle, which actuator selectively enables or disables the powered component in response to the actuator control signal.

2. The security system of claim 1, further comprising:
a user interface located with the vehicle, which user interface selectively provides a user request signal to the vehicle controller; and
wherein the vehicle controller is adapted to communicate with the base controller in response to the user request signal.

3. The security system of claim 2, wherein the user interface includes at least one of a keypad and a fingerprint reader.

4. The security system of claim 1, wherein the powered component comprises a fluidly powered component.

5. The security system of claim 4, wherein the fluidly powered component comprises a pneumatically powered component.

6. The security system of claim 4, wherein the actuator comprises one of a valve and an air regulator.

7. The security system of claim 4, wherein the fluidly powered component comprises landing gear for a trailer.

8. The security system of claim 4, wherein the fluidly powered component comprises one of a lift gate, a platform lift, a rear stabilizer, a hopper gate, a vehicle door lock and a roll-top cover.

9. The security system of claim 1, wherein the GPS sensor includes a transmitter for communicating between the vehicle controller and the base controller.

10. A method for securing a vehicle having at least one powered component, the method comprising:
providing a security system having a GPS sensor and at least one actuator located with the vehicle, which actuator is selectively operable to enable or disable the powered component;
providing a location signal indicative of a geographical position of the vehicle via the GPS sensor; and
enabling or disabling the powered component via the actuator based on at least one of the location signal or a user request.

11. The method of claim 10, wherein
the security system includes a base controller located independent of the vehicle, and a vehicle controller located with the vehicle;
the step of providing a location signal further comprises the steps of providing the location signal to the base controller, and sending a base control signal to the vehicle controller; and
the step of enabling or disabling the powered component further comprises the step of sending an actuator signal from the vehicle controller to the actuator based on at least one of the location signal or the user request.

12. The method of claim 10, further comprising the step of providing the user request via a user interface located with the vehicle.

13. The method of claim 12, wherein the step of providing the user request further comprises the step of inputting at least one of a code, a command and a message into the user interface.

14. The method of claim 10, further comprising the step of at least one of identifying a user and verifying an identity of the user inputting the user request.

15. The method of claim 10, further comprising providing a power source for fluidly driving the powered component.

16. The method of claim 15, wherein
the actuator enables the powered component by permitting fluid to flow from the power source to the powered component; and
the actuator disables the powered component by preventing fluid to flow from the power source to the powered component.
